(19) United States
(12) Patent Application Publication
(10) Pub. No.: US 2007/0019801 A1
(43) Pub. Date: Jan. 25, 2007

(54) Method, system and apparatus for tracking support calls and determining proactive support strategies

(75) Inventors: Kent Evan Brenneman, Georgetown, TX (US); Lewis Carl Simons, Round Rock, TX (US); Robert Andrew Rose, Austin, TX (US)

Correspondence Address: BAKER BOTTS, LLP, 910 LOUISIANA, HOUSTON, TX, 77002-4995, US

(73) Assignee: Dell Products L.P.

(21) Appl. No.: 11/171,614

(22) Filed: Jun. 30, 2005

(51) Int. Cl. H04M 3/00

(52) U.S. Cl. 379/265.11

(57) ABSTRACT

A method and system are provided for increasing the efficiency and satisfaction rating of service calls regarding a product. The system can contain a telecommunications system to receiving calls from customers, and for contacting the customers in return. Databases retain information regarding the products sold to the customers, and the customer's calls to the call center. When a given customer calls the call center more often within a given time period, the customer's call is forwarded to another, more specialized queue so that more intensive attention is given to resolve the customer's problem. At that point, the extent and quality of contact with the customer is carefully recorded and correlated with similar problems so that swift resolution of the problem is achieved.

### CROSS REFERENCE TO RELATED INVENTIONS

This application is related to U.S. application Ser. No. ______ [Attorney Docket No. 016295.1929] entitled “Method, System and Apparatus for Maintaining Ownership of Service Calls Within an Organization” by Hancock, et al. which was filed on Jun. 30, 2005.

### BACKGROUND

1. Field of the Invention

The present invention relates to control centers. More specifically, the present invention is directed to a system and method for allocating support resources to handle service calls regarding information handling systems.

2. Background of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

As information processing systems have become more pervasive, they have also become more complex because those systems are tasked more extensively. As a result, failure of the information processing systems can have a significant and deleterious affect on the performance of an organization. As a consequence, companies that manufacture the information processing systems are often asked by their customers to service broken machines.

For years, companies that manufacture information handling systems have strove to provide better customer service, particularly in the event of system failure. Many original equipment manufacturers (“OEM”) use call centers where customers with problems may contact company representatives to obtain solutions to their problems. In many cases, the problem can be resolved with a single telephone call. While much effort has been expended, customers are still dissatisfied. On average, approximately 18,000 customers called back to Customer Support three or more times in a given week, ultimately generating almost 70,000 calls in that week. These large numbers of calls generate are upsetting to users and unsatisfactory to the OEM. There is a need in the art to reduce the level of dissatisfaction of consumers and decrease the number of repeat phone calls to less than three in a seven-day period.

### SUMMARY OF THE INVENTION

The present invention solves the problems inherent in the art by providing a system and method having at least one or more databases, each database having one or more tables. A database engine is made operative with the databases. The database engine capable of executing one or more SQL (or equivalent) statements on the database to obtain one or more result sets. The database engine is also operative with a network so that users in disparate locations can query the database and obtains result sets. The invention contemplates one or more call centers, with the call centers staffed by one or more technicians. The technicians can be divided into various skill levels, with the first set of technicians in the first queue handling routine calls from customers. If a customer cannot find satisfactory resolution from the efforts of the first technician, the customer normally makes additional calls to the call center. If the problem remains unresolved, the customer is less satisfied with the product and the manufacturer. To remedy the situation, the calls from customers are monitored and recorded in the databases. When the frequency of calls from a given customer (for the same problem) exceed a predetermined threshold, the call is transferred to a second queue manned by a second (more highly skilled) set of technicians. To help the second set of technicians, information about the product and calls from customers with similar problems are correlated via queries made to the databases via the database engine on the network that is integrated with the call center.

Armed with additional information and possessing additional skills, the second set of technicians can offer additional troubleshooting suggestions to the customer. In addition, the second set of technicians are allowed to arrange teleconferences with the customer at times convenient to that customer (preferably allowing the customer enough time to complete the additional diagnostic troubleshooting steps). Events within the database are automatically scheduled for the second set of technicians to remind them to call the customer back to find out if the diagnostic and/or troubleshooting steps were effective). Call backs from the manufacturer at convenient times yields surprising satisfaction ratings from customers.

### BRIEF DESCRIPTION OF THE DRAWINGS

A more complete understanding of the present disclosure and advantages thereof may be acquired by referring to the following description taken in conjunction with the accompanying drawings, in which like reference numbers indicate like features, and wherein:

FIG. 1 is a block diagram of an information handling system according to the teachings of the present invention.

FIG. 2 is a flow chart illustrating an embodiment of a method according to the teachings of the present invention.

FIG. 3 is a block diagram illustrating an embodiment of a system according to the teachings of the present invention.

The present disclosure may be susceptible to various modifications and alternative forms. Specific exemplary embodiments thereof are shown by way of example in the drawing and are described herein in detail. It should be understood, however, that the description set forth herein of specific embodiments is not intended to limit the present disclosure to the particular forms disclosed. Rather, all modifications, alternatives, and equivalents falling within the spirit and scope of the invention as defined by the appended claims are intended to be covered.

### DETAILED DESCRIPTION

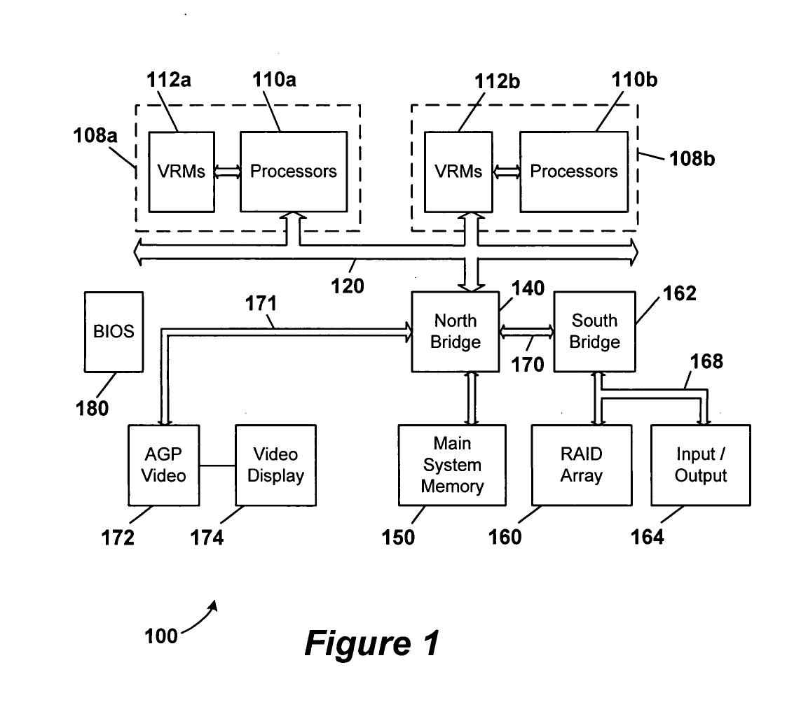

Elements of the present disclosure can be implemented on a computer system, as illustrated in FIG. 1. Referring to FIG. 1, depicted is an information handling system, generally referenced by the numeral 100, having electronic components mounted on at least one printed circuit board (“PCB”) (not shown) and communicating data and control signals there between over signal buses. In one embodiment, the information handling system may be a computer system. The information handling system may be composed processors 110 and associated voltage regulator modules (“VRMs”) 112 configured as processor nodes 108. There may be one or more processor nodes 108, one or more processors 110, and one or more VRMs 112, illustrated in FIG. 1 as nodes 108a and 108b, processors 110a and 110b and VRMs 112a and 112b, respectively. A north bridge 140, which may also be referred to as a “memory controller hub” or a “memory controller,” may be coupled to a main system memory 150. The north bridge 140 may be coupled to the processors 110 via the host bus 120. The north bridge 140 is generally considered an application specific chip set that provides connectivity to various buses, and integrates other system functions such as memory interface. For example, an INTEL® 820E and/or INTEL® 815E chip set, available from the Intel Corporation of Santa Clara, Calif., provides at least a portion of the north bridge 140. The chip set may also be packaged as an application specific integrated circuit (“ASIC”). The north bridge 140 typically includes functionality to couple the main system memory 150 to other devices within the information handling system 100. Thus, memory controller functions, such as main memory control functions, typically reside in the north bridge 140. In addition, the north bridge 140 provides bus control to handle transfers between the host bus 120 and a second bus(es), e.g., PCI bus 170 and AGP bus 171, the AGP bus 171 being coupled to the AGP video 172 and/or the video display 174. The display 174 can be a monitor, or the information to be displayed may be sent to another device, such as a printer (not shown). The second bus may also comprise other industry standard buses or proprietary buses, e.g., ISA, SCSI, USB buses 168 through a south bridge (bus interface) 162. These secondary buses 168 may have their own interfaces and controllers, e.g., RAID Array storage system 160 and input/output interface(s) 164. Finally, a BIOS 180 may be operative with the information handling system 100 as illustrated in FIG. 1. The information handling system 100 can be combined with other like systems to form larger systems. Moreover, the information handling system 100, can be combined with other elements, such as networking elements and or other information handling systems, to form even larger and more complex information handling systems such as, for example, clusters or other enterprise resource planning system, such as an enterprise resource planning portal.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory as described above. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

The information handling system described above, or similar systems, may be used to implement the systems and methods described herein. It should be noted that the information handling system needed to implement the methods and systems described herein may be implemented in hardware, in software (in the form of one or more instructions), or in any combination of hardware or software. Moreover, no specific software language is required to implement the systems and methods described herein, and they may be implemented using any desired programming language.

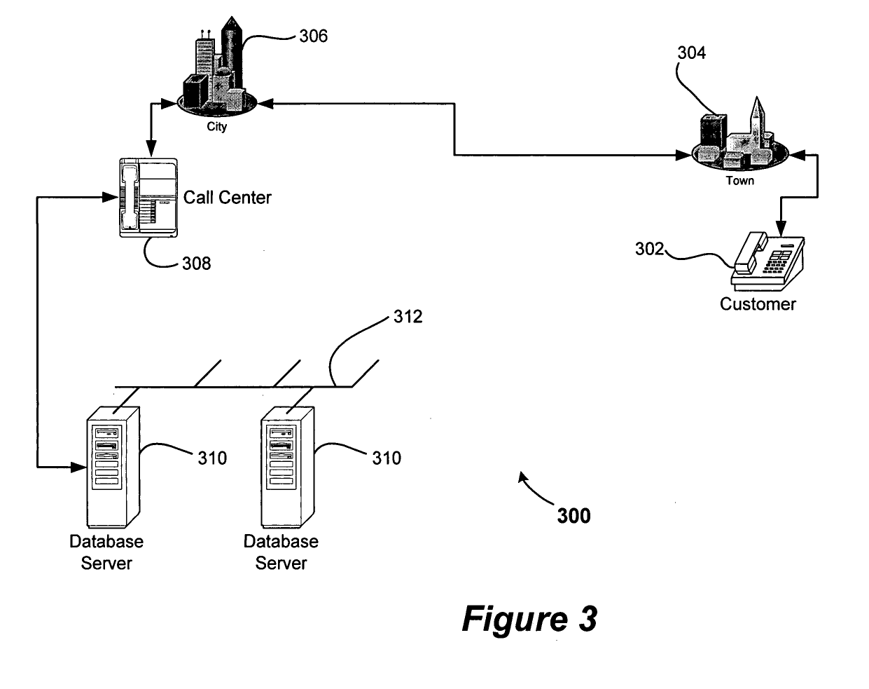

In one embodiment, the manufacturer of a product maintains a call center where customers may call to seek solutions to problems associated with the product. FIG. 3 illustrates an embodiment of the system disclosed herein. Specifically, the system 300 has a customer interface device, such as the telephone 302, although other devices, such as an information handling system could be used with equivalent effect. The customer interface device is connected via a network, such as a telecommunications network, from their place of residence (town 304) to the location of the call center 308 (city 306). The call center 308 houses two or more technicians, typically with disparate skill levels. The call center 308 is operative with a network 312 having one or more database servers 310. The database server 310 contains one or more databases. Each database contains one or more data tables. A database engine, typically executing on the database server 310, is used to receive query requests from the call center 308 and perform the queries on the databases and return the results of the queries to the technicians at the call center 308. The databases can contain, for example, information about the customer's problem, the number of times that that customer has called about the same problem (or different problems) and all calls from all customers about the same, similar, or dissimilar problems. Similarly, the databases can contain information about the customer's product, such as model number, configuration, date of manufacture (of the final product as well as any component contained therein), and any other piece of information retained during the manufacturing process.

The method disclosed herein utilizes the information handling system described above. In general, upon receiving a customer call for a problem in which the customer has called repeatedly, a queue agent at the call center 308 checks the database for the next customer to call (per the date stamp) and checks several things in the tag (associated with the customer's problem) to confirm certain organizational issues should they exist. The queue agent then calls the customer. If the customer does not answer, then the agent will attempt to call back, for example, four times or leave a voicemail message. If the customer does answer, the troubleshooting methodology is initiated. Other aspects of the method track/record whether or not the queue agent called back within a certain period of time (e.g., 72 hours) and what results were obtained. Other aspects of the method specify what to do in certain events (such as when a voicemail is left), or when information is loaded into the database regarding the results of the method disclosed herein for purposes of tracking and evaluation. In short, the methodology provides:
1. A customer call is received an placed into a general customer queue;
2. A database is queried to determine how many times the customer has called within a given period of time and the call is prioritized on that basis. For example, a customer that places his seventh call that day is placed higher in the priority queue than a customer who is making his fourth call in seven days. Although the call-period basis is described, another basis can be used, such as the type of problem, or the customer's service contract level.
3. The main database server is queried and the customer's call can be characterized (in comparison to other calls stored within the database). The database can be used to analyze the data from many previous customer calls and vendor service notices so that the customer's call can be routed to a service agent who is familiar with that particular problem.

Use of the Database can enable the tailoring of call-center resources by striking the right balance of call prioritization and team routing. The database can be refreshed periodically (preferably as often as possible) to enable the various teams to capitalize on the information contained within the database and thereby service customers more quickly and effectively.

In one embodiment, the customer information database does not update the parts database, the parts database being the repository of information concerning the parts that made the particular product in question. Instead, a temporary snapshot of the parts of the information is used for the day's activities. Subsequent snapshots of the parts database are used for future activities at the proscribed refresh periods. Because there can be a discrepancy in the two data sets (the primary data set, and the snapshot), changes to one database must be reconciled with the other database. For example, when a job is closed, the snapshot database may be updated, but the primary database would not be updated until the next refresh period.

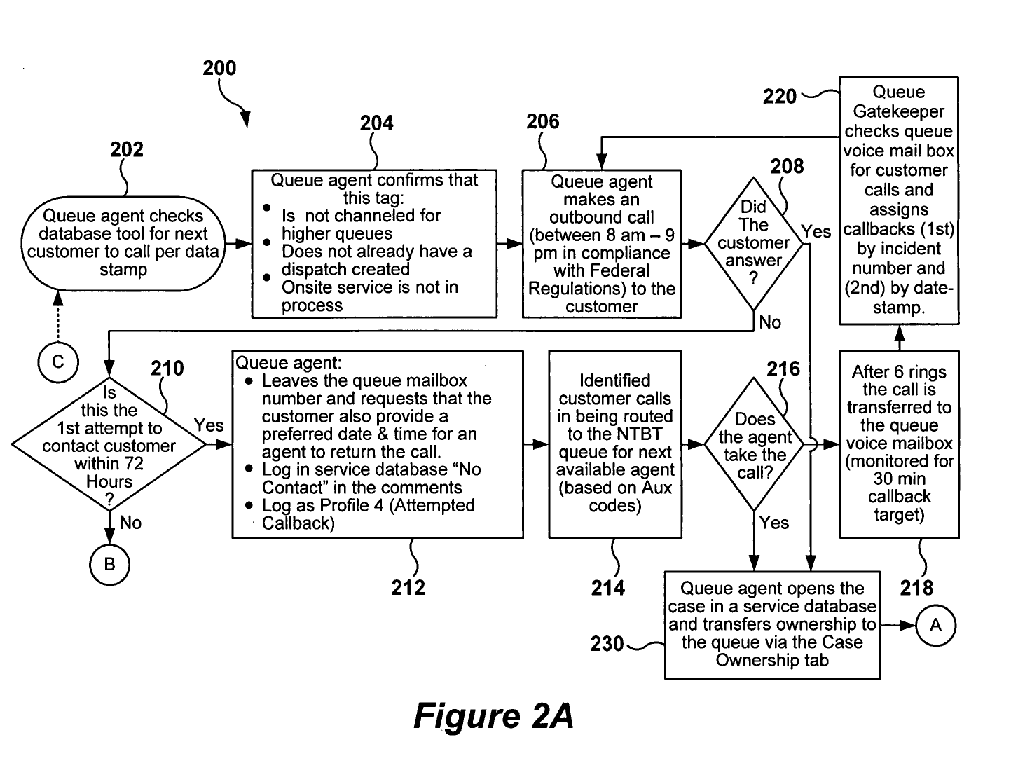

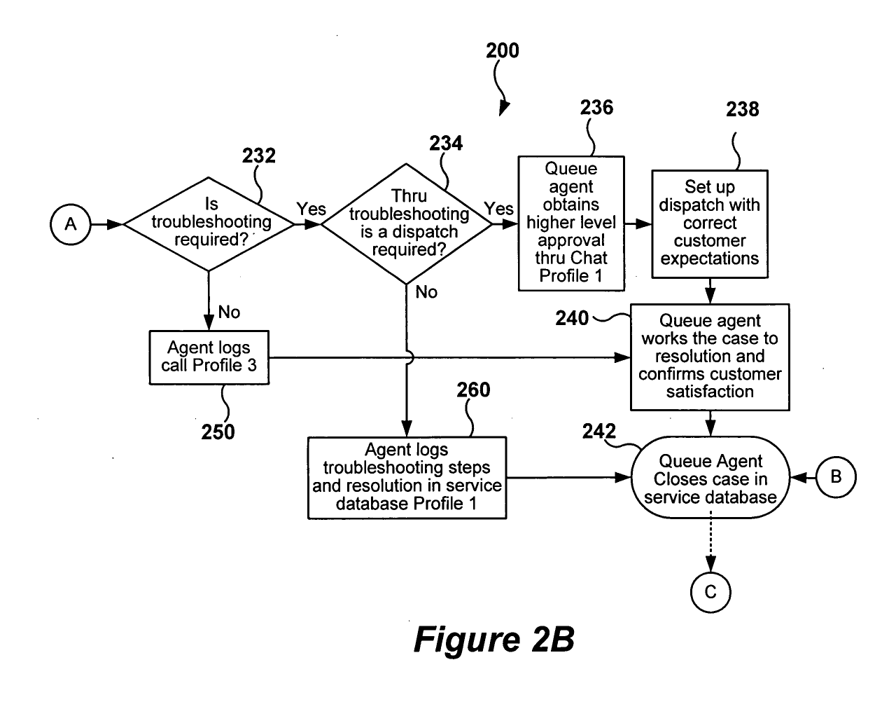

A more detailed explanation of the method disclosed herein can be had by reference to FIG. 2. The method 200 illustrates a closed loop embodiment of the method. In this illustrative embodiment, the customer call rate has already exceeded the threshold where additional attention is required by a second set of technicians. At 202, the queue agent checks the customer database for the next customer that is to be contacted. The queue agent confirms 204 that the customer's tag is timely and/or relevant, typically by determining that it has not been channeled to a work queue that provides enhanced services, does not already have a dispatch entry created, or does not have onsite service in progress. Other checks can be made at this point to preclude duplicity of effort. The queue agent them makes 206, and outbound call to the customer while obeying, for example, the applicable governmental provisions regulating when calls may be placed to consumers. The queue agent then determines if the customer answered 208. If the customer does answer, then the method moves to event 230 and continues thereon. Otherwise, if the customer does not answer, then the queue agent determines 210, e.g., by reference to a service database, whether or not this is the first attempt to contact the customer within a predetermined time period (e.g., 72 hours). If not, then the method moves to event 242. If the call was the first attempt to contact the customer, then the queue agent takes one or more actions 212, such as leaving the queue's mailbox number and requests that the customer also provide a preferred date and time for an agent to return the call; log into the database and note that the customer did not answer; and/or log the result as an attempted callback. The system can then identify 214 the customer calls (prompted by the call 206) that are being routed to the queue as being available for the next available agent (based on, for example an internal auxiliary code). If the agent takes the call 216, the method moves to event 230. Otherwise, if the agent does not take the call 216, after a predetermined number of rings (e.g., five), the customer's call is transferred to a voice mailbox belonging to the queue that can be monitored for rapid callback 218 (e.g., within thirty minutes). A gatekeeper of the queue checks 220 the voice mailbox of the queue for customer calls and assigns calls according to a prearranged method, such as assigning callbacks by incident number, or by date stamp, or some other sequence or combination of factors (such as the customer's requested callback time), and the method moves back to event 206.

At event 230, the agent opens the case in a service database and transfers ownership of the tag to the queue, now associated with a case ownership tab. An agent (or the system) determines 232 whether troubleshooting is needed. The linking of the call center to the equipment database (e.g. a database containing information about the parts and configuration of the equipment in question) and the service database enables the agent to make a reasoned judgment. Similarly, logic within, for example, the database server 310 can periodically query the service database and the equipment database and determine if, based on previous problems experienced by the same or other customers, that certain troubleshooting tasks are in order. If no troubleshooting steps are warranted, then the queue agent logs 250 the calls in a certain way (e.g., designating it as “Profile 3”) and the method moves to step 240 (discussed infra).

If additional troubleshooting is needed 232, then a check 234 is made to determine if, through troubleshooting, a dispatch (of personnel and/or equipment to the customer's location) is required. If no dispatch is required, then the agent logs 260 troubleshooting steps and their resolution in the customer database and may optionally designate the tag as, for example, “Profile 1” and the method moves to step 242. If a dispatch is required, then the agent obtains 236 approval from higher authority to obtain permission to make the dispatch. The queue agent then sets up 238 the dispatch with the correct customer expectations. The queue agent then works 240 the case to resolution and confirms customer satisfaction. Once settled, the queue agent then closes 242 the case in the service database and moves on to the next call 202.

In another embodiment, the information contained in the service database and/or the equipment database can be queried to ascertain the quality of service provided to one or more customers. Moreover, the queries of the service and/or equipment databases can also be used to determine the quality of parts used in the products. The results of the queries can be used for reporting to management, who can then take corrective action as needed. Moreover, the queries can be conducted by autonomous agents, such as software programs implemented on the information handling system, to provide real-time feedback to the queue agents regarding certain parts or service procedures implicated in the current service calls by customers, such as response times, call-back times, troubleshooting procedures, and the like. Such an implementation by management and/or autonomous agents enables real-time and/or continuous improvement in the methods disclosed herein, and otherwise provide higher quality service to customers.

The invention, therefore, is well adapted to carry out the objects and to attain the ends and advantages mentioned, as well as others inherent therein. While the invention has been depicted, described, and is defined by reference to exemplary embodiments of the invention, such references do not imply a limitation on the invention, and no such limitation is to be inferred. The invention is capable of considerable modification, alteration, and equivalents in form and function, as will occur to those ordinarily skilled in the pertinent arts and having the benefit of this disclosure. The depicted and described embodiments of the invention are exemplary only, and are not exhaustive of the scope of the invention. Consequently, the invention is intended to be limited only by the spirit and scope of the appended claims, giving full cognizance to equivalents in all respects.

What is claimed is:

1. A computer-readable medium containing a data structure, comprising:
instructions for receiving, by a first queue agent, one or more calls from a customer about a product;
instructions for determining if the customer has called a predetermined number of times within a first predetermined time period; and
if the customer has called a predetermined number of times within the first predetermined time period, then instructions for forwarding information about the customer call and the product to a second queue agent, and instructions for contacting the customer within a second predetermined time period.

2. A system comprising:
a database having one or more tables;
a database engine operative with the database, the database engine capable of executing one or more SQL statements on the database, the database engine further operative with a network;
a call center, the call center having one or more call center technicians, the one or more call center technicians having access to an information handling system, each information handling system operative with the network to enable the technician to track and respond to calls from customers at disparate times with information retrieved from the database.

3. The system of claim 1, wherein the database is linked to one or more secondary databases containing information on one or more parts that are used in one or more products.

4. The system of claim 1, wherein the database is linked to one or more secondary databases containing information on one or more service events for one or more products.

5. A method for increasing efficiency of a call center comprising:
receiving, by a first queue agent, one or more calls from a customer about a product;
determining if the customer has called a predetermined number of times within a first predetermined time period; and
if the customer has called a predetermined number of times within the first predetermined time period, then forwarding information about the customer call and the product to a second queue agent, contacting the customer within a second predetermined time period.

6. The method of claim 5, wherein the step of determining comprises:
querying a database containing information on one or more parts that are used in the product.

7. The method of claim 5, wherein the step of determining comprises:
querying a database containing information on one or more service events for the product.

8. The method of claim 5, further comprising:
querying a database containing information on one or more service events and one or more parts that are used in the product to obtain one or more database results.

9. The method of claim 8, further comprising:
reporting the results.

10. The method of claim 8, further comprising:
modifying one or more procedures based upon the results.

11. The method of claim 10, wherein the step of modifying is performed in real-time.
